(19) United States
(12) Patent Application Publication
(10) Pub. No.: US 2014/0289097 A1
(43) Pub. Date: Sep. 25, 2014

(54) AUTOMATED INFORMATION AND ANALYTICAL LOAN PORTFOLIO MANAGEMENT SYSTEM

(71) Applicant: Vladimir Georgievich BABIKOV, Moscow (RU)

(72) Inventor: Vladimir Georgievich BABIKOV, Moscow (RU)

(21) Appl. No.: 13/847,732

(22) Filed: Mar. 20, 2013

(51) Int. Cl. G06Q 40/00

(52) U.S. Cl. CPC G06Q 40/025
USPC 705/38

(57) ABSTRACT

The proposed automated information and analytical loan portfolio management system relates to systems intended to make predictive estimates of financial risks and simulate loan portfolio management scenarios. As a result, the efficiency of loan portfolio management increases and risks in managing the assets and liabilities reduce. The system comprises an operator's workstation connected by communication links to a server including: a primary transfer matrix generation subsystem, a portfolio quality characteristics generation subsystem, and external impact factor (macro-factor) generation subsystem, a portfolio scenario characteristics computation subsystem, a funding costs and market risk computation subsystem, and a report generation subsystem. The proposed system allows extending a range of loan portfolio management means.

### CROSS-REFERENCE TO RELATED APPLICATION

This U.S. patent application claims priority under 35 U.S.C. 119 (a) through (d) from a Russian Federation patent application RU2012111110/08 filed on 23 Mar. 2012.

### FIELD OF THE INVENTION

The inventive subject matter relates to computer assisted systems, intended for making predictive estimates of loan, market, and strategic risks; for simulating scenarios of loan portfolio management (business scenarios); for simulating macroeconomic scenarios; and for selecting optimum management solutions to reduce relevant risks. The proposed invention is particularly suitable for managing loan portfolios of banks or other financial institutions.

### BACKGROUND OF THE INVENTION

Known in the related art are various systems to generate and manage loan portfolios. Practical implementation of such system not only requires special knowledge but more often than not is an art, and therefore the important object is correct assessment of the existing portfolio—supervision of all acts performed by managers. Generally, a simple assessment based on statistics showing how many loans within the loan portfolio became overdue for a certain period is taken for an aggregate result. However, an assessment of loan portfolio quality merely by tracking overdue loans statistics cannot be considered as consistent, since it makes no allowance for external factors affecting the loan portfolio and does not quarantine a similar result in the future. The loan portfolio should be assessed comprehensively based not only on the figures of losses for a certain time period but also on macroeconomic data and assessment of economic situation impact on the loan portfolio.

The closest related art to the claimed invention is a mortgage and consumer loan portfolio management system (U.S. Pat. No. 6,249,775B1, 2001 and U.S. Pat. No. 7,020,631B2, 2009). The mortgage and consumer loan portfolio management system is developed in the form of an analytic tool designed to improve analysis of past and future performance of loan portfolios. The system aggregates loan units into loan vintages, wherein the loans in each vintage originate within a predetermined time interval of one another. Owing to such aggregation separate vintages may easily be compared with one another. An early warning component of the system predicts delinquency rates expected for a portfolio of loans during a forward looking time window. A matrix link component combines the loan vintage analysis with the early warning component and predicts the default rate of the loan portfolios at a selected future point in time. The results of the analysis are graphically depicted and automatically fed back to provide “yes” or “no” decisions in respect of investments in various loan portfolios.

The main object of aforesaid related art system is to assist in understanding of loan portfolio performance and set up an automated and dynamic system capable of predicting the future performance of the portfolio on the basis of its past performance and also capable of assisting in decision taking at the loan application stage.

However, there is still a need in a system having a loan portfolio management function and improving accuracy and reliability of the prediction of loan portfolio performance, and loan portfolio quality assessment.

### BRIEF SUMMARY OF THE INVENTION

The primary object of the present invention is to extend a range of loan portfolio management means. According to the present invention, this object is achieved by designing an automated information and analytical loan portfolio management system including:

I) a server (that can also be called a ‘system server’ serving requests of other computer programs, typically called ‘clients’ run either on the same computer, or connected to the ‘server’ via a network), wherein the server comprises the following subsystems: (A) a subsystem for generating primary matrices to support transfer and loading of a main base of loan portfolio performance; (B) a subsystem for loading historical and producing scenario quality characteristics and volumes of loan portfolio vintages and loading price policies; (C) a means for loading historical values of a macro-factor and producing scenario values of such macro-factor; (D) a subsystem for computing quality characteristics and the macro-factor, computing scenario characteristics of the loan portfolio; (E) a subsystem for computing costs of funding, interest payments, losses as a result of market risk occurrence; and (F) a subsystem for generating reports with the aid of algorithms for report generation on the basis of data calculated by aforesaid subsystems (A)-(E)”; and

II) at least one operator's workstation (client) comprising: (a) a data input device; (b) a device for receiving data on financial instruments, data on basic characteristics of the financial instruments, data on transactions with the financial instruments, data on risk factor historical values; (c) intermediate data storage and processing devices; and (d) a data output device; wherein the operator's workstation is linked to the server; wherein the subsystems (A), (B), (C) and (E) are managed from the operator's workstation using a functional link between the intermediate data storage device (c) and the subsystems (A), (B), (C) and (E).

The proposed automated information and analytical system increases the efficiency of loan portfolio management and reduces risks during the managing of liabilities and assets.

### BRIEF DESCRIPTION OF DRAWINGS

The present invention will be described herein below with reference to a specific embodiment thereof taken in conjunction with the accompanying drawings in which:

FIG. 1 depicts a general block diagram of the computer system according to a preferred embodiment of the claimed invention;

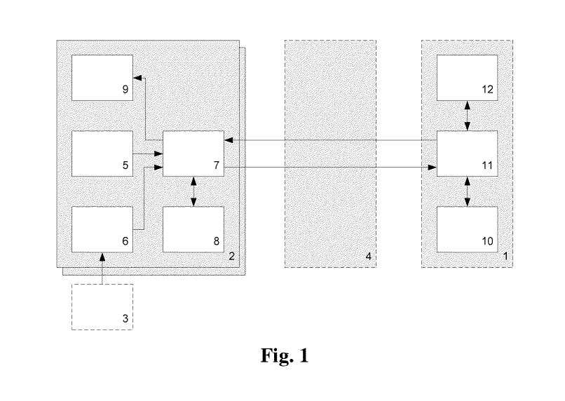

FIG. 2 depicts a block diagram of components of the system server according to a preferred embodiment of the claimed invention; and

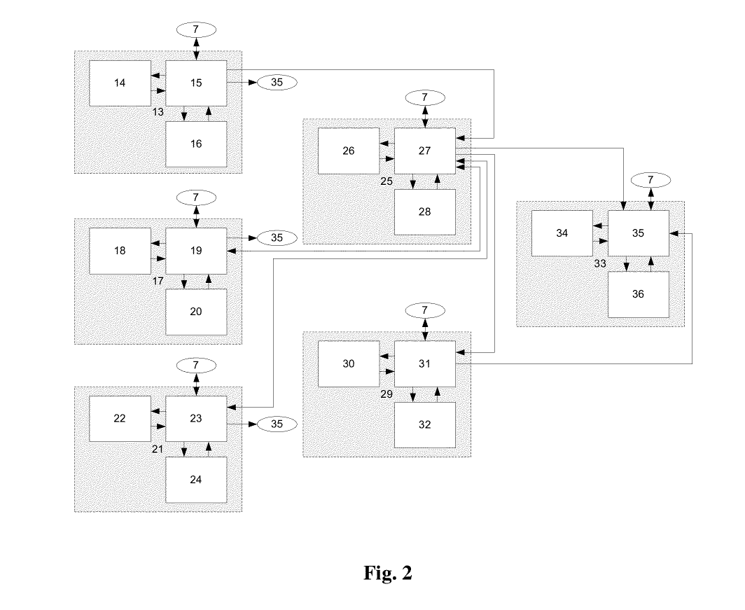

FIG. 3 depicts a block diagram of subsystems of the computer system according to a preferred embodiment of the claimed invention.

### DETAIL DESCRIPTION OF PREFERRED EMBODIMENTS OF INVENTION

While the invention may be susceptible to embodiment in different forms, there are described in detail herein, specific embodiments of the present invention, with the understanding that the present disclosure is to be considered an exemplification of the principles of the invention, and is not intended to limit the invention to that as exemplified herein.

The automated information and analytical loan portfolio management system (herein below referred to as ‘inventive system’) may be based on various computer systems; however, the preferred embodiment thereof is essentially a system in the form of a well-known “client/server” network including a server connected to system operators' workstations (client computers) and data sources with aid of various communication links, e.g., fiber-optic, telephone, radio, satellite communications, etc. The workstation may utilize a standard IBM-compatible personal computer or a portable computer using the proven Microsoft Windows operating system or an equivalent thereof. The system operator's workstation is composed of a data input/output device (keyboard, “mouse,” touch screen, etc.), a data receiving device (hard disk storage, compact disk drive or floppy drive), intermediate data storage and processing devices in the form of RAM of the client computer, a microprocessor and data input/output devices (e.g., display, printer).

The inventive system includes a server (1) connected to system operators' workstations (client computers) (2) and data sources (3) through various communication links (4). The workstations (2) each includes a data input device (5), a data receiving device (6), intermediate data storage devices (7), a microprocessor (8), and a data output device (9). The server (1) includes a microprocessor (10), RAM (11) and data media (or a hard disk 12). The server (1) accommodates a plurality of subsystems described below.

The data sources (3) are preferably information systems implemented in the form of MS SQL Server, Oracle, SAS, Teradata, ODBC or similar data bases, the data from which are transmitted through the communication links, e.g., fiber-optic. telephone, satellite communications, etc.

The server (1) includes the following subsystems:
a subsystem (13) for generating primary matrices to support transfer and loading of a main base of loan portfolio performance, including a resource (14), the microprocessor (10), cells (15) of RAM (11), a segment (16) of the hard disk (12);
a subsystem (17) for loading historical and producing scenario quality characteristics and volumes of loan portfolio vintages and loading price policies, including a resource (18), the microprocessor (10), cells (19) of RAM (11), a segment (20) of the hard disk (12);
a subsystem (21) for loading historical values of a macro-factor and producing scenario values of such macro-factor, including a resource (22), the microprocessor (10), cells (23) of RAM (11), a segment (24) of the hard drive (12);
a subsystem (25) for computing quality characteristics and a macro-factor, computing scenario characteristics of a loan portfolio, including a resource (26), the microprocessor (10), cells (27) of RAM (11), a segment (28) of the hard drive (12);
a subsystem (29) for computing costs of funding, interest payments, losses as a result of market risk occurrence, including a resource (30), the microprocessor (10), cells (31) of RAM (11), a segment (32) of the hard drive (12).

All the subsystems (13), (17), (21), (25), (29) include intermediate report generation and data output modules, wherein data are output through a functional link to the intermediate data storage device (7).

The server (1) also includes a subsystem (33) generating reports according to algorithms for report generation on the basis of the data computed by other subsystems of the system, the subsystem (33) includes a resource (34), the microprocessor (10), cells (35) of RAM (11), a segment (36) of the hard drive (12).

The subsystems (13), (17) and (21) communicate with the subsystem (25) through functional links established between the RAM cells (15) and (27), (19) and (27), (23) and (27), whereas the subsystems (25) and (29) are interconnected through a functional link established between the RAM cells (27) and (31).

The functional links between the cells (15) and (35), (19) and (35), (23) and (35), (27) and (35), (31) and (35) connect the subsystems (13), (19), (23), (25) and (29) in series with the subsystem (33). The subsystem (33) has its output connected through the intermediate data storage and processing device (7) to the data output device (9) of the system.

The system operator stationed at the workstation (2) communicates with the server (1) using a single graphical user interface and the functional links of the intermediate data storage device (7) with all computer subsystems.

Each of the aforesaid subsystems (13), (17), (21), (25), (29) of the server (1) forms a basis for one computer subsystem, which is essentially an aggregate of data banks intended to store data and hardware and/or software/hardware modules intended to establish functional links between the subsystems, input external data to the system, convert data and transmit them to other subsystems. The data bank is meant to be a set of ordered data on physical data media—electromagnetic, optical or any other. The data banks relating to different subsystems may be stored both separately in different data bases and collectively in the same data base.

The subsystem (13) of the server (1) is intended to implement a subsystem (37) that stores and processes data on historical performance of the loan portfolio and to generate primary transfer matrices (patterns).

The subsystem (17) is intended to implement a subsystem (38) that loads, generates and stores quality characteristics of the loan portfolio.

The subsystem (21) is intended to implement a subsystem (39) that loads historical data of macroeconomic indicators and forecasts thereof, generates, simulates and stores scenarios of macroeconomic indicators and a macro-factor.

The subsystem (25) is intended to implement a subsystem (40) tuning a computation algorithm for scenario characteristics of the portfolio and computing these characteristics.

The subsystem (29) is intended to implement a subsystem (41) computing costs of funding, interest payments, a market risk and possible losses resulting from implementation of unfavorable scenarios.

In this description, a term ‘module’ can be used for identifying a part of a subsystem. A term ‘means’ is used for identifying both: subsystems and modules.

A report generation module (42) is built around the subsystem (33).

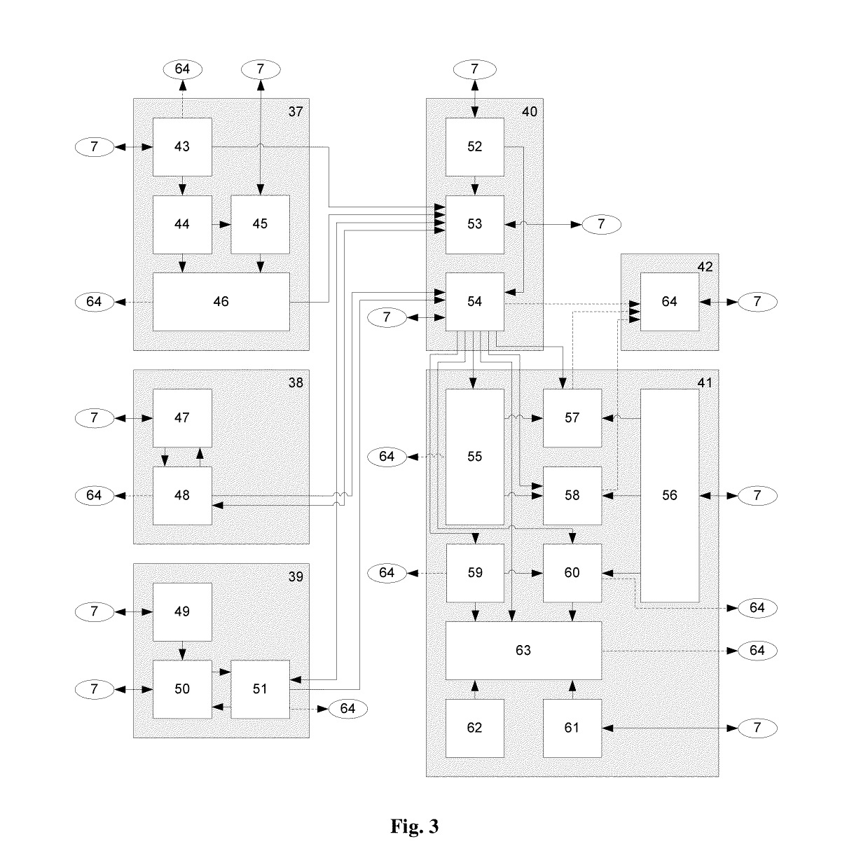

Referring to FIG. 3, the subsystem (37) includes:
a module (43) loading and storing data on historical performance of the loan portfolio;
a module (44) automatically generating primary transfer matrices (patterns);
a module (45) in which an interface is implemented to directly generate and store primary transfer matrices and to load the primary transfer matrices computed with the aid of the module (44) or other systems; and
a module (46) includes final versions of the primary matrices (patterns) to be exported to the portfolio characteristics computation subsystem (40) and to the report generation module (42).

The subsystem (38) includes:
a module (47) loading and producing quality characteristics by vintages for already extended loans, said module being directly responsible for loading and producing quality characteristics and setting scenario characteristics of future vintages; and
a module (48) exchanging scenario characteristics with the portfolio characteristics computation subsystem (40) and exporting such characteristics to the report generation module (42).

The subsystem (39) includes:
a module (49) loading historical trends of macroeconomic indicators and forecasts thereof;
a module (50) generating macroeconomic scenarios and a macro-factor (the macro-factor is essentially an internal system variable) and simulating a stochastic process of macro-factor behavior;
a module (51) generating a matrix responsive to environmental impacts, loading and exchanging historical and scenario values of said macro-factor and exchanging macro-factor values with the portfolio characteristics computation subsystem (40) and providing export to the report generation module (42).

The subsystem (40) includes:
a module (52) generating an error minimization functional;
a module (53) computing historical values of quality characteristics of the loan portfolio and the macro-factor;
a module (54) computing scenario characteristics of the loan portfolio, said module including a means to transport data to the market risk computation subsystem (41) and to the report generation module (42).

The subsystem (41) includes:
a module (55) computing and storing data on principal payments on debt arising from new extensions (detailed by loan types including loan term in case of consumer loans or mortgage);
a module (56) computing and storing historical interest rates with different due dates for various financial instruments available to a financial and credit organization;
a module (57) computing and storing data on costs of funding of new extensions for various funding scenarios (short-term borrowings, match-funding, etc.);
a module (58) computing and storing data on interest payments for various funding scenarios;
a module (59) computing and storing data on principal payments as referred to the current portfolio (detailed by various types of loans including the term for which consumer or mortgage loans are extended);
a module (60) computing a current value of debt servicing for various funding scenarios;
a module (61) generating interest rate performance scenarios;
a module (62) generating stochastic historical series of interest rate performance; and
a module (63) computing costs of funding, interest payments and market risk for various interest rate performance options and various funding scenarios.

The modules (55), (57) through (61) and (63) include a means exporting data to the report generation module (42).

The information and analytical system functions as follows. Actual data on balances (units) break-down by (delinquency) buckets, transfers of balances (units) from one bucket to another for each loan vintage or loan type (e.g., loan term) are loaded into the subsystem (37) storing and processing data on historical performance of the loan portfolio and generating primary transfer matrices. These data are loaded for the entire loan portfolio lifetime with a monthly discretization (or another discretization as selected by an analyst/operator).

| Start- | | | | | | |
|---|---|---|---|---|---|---|
| Date | ObsDate | Bucket1 | Sum1 | Bucket0 | Sum0 | irp |
| 03.2007 | 10.2008 | 0 | 915175 | 0 | 1231424 | 32351 |

wherein:
StartDate—month of origination;
ObsDate—month of observation;
Bucket0—Old (delinquency) bucket from which balance transfers during the month under monitoring;
Bucket1—(delinquency) bucket to which balance is transferred during the month under monitoring;
Sum0—initial balance in the (delinquency) bucket from which transfer occurs;
Sum1—balance that transfers from one bucket to another bucket;
irp—amount of interest payments for the month under monitoring in respect of a pertinent group.

The data are processed in pertinent modules of the subsystem storing and processing data on historical performance of the loan portfolio and generating primary transfer matrices (37) whereby data on loan portfolio performance and primary transfer matrices are generated, said data and matrices further conveyed to the subsystem that tunes a computation algorithm for scenario characteristics of the portfolio and computes these characteristics (40).

At this stage the primary transfer matrices are controlled by plotting graphs illustrating probability functions of transfer from one bucket to another depending on the loan vintage age (44, 45). Also, at this stage provision may be made for correction of said functions by the system operator and for loading said primary transfer matrices from other systems. The primary transfer matrices thus prepared are stored in the module (46) and conveyed to the computation subsystem (40) and to the report generation module (42).

Before the data processing procedure is started, the error minimization functional (52) is set. Then, the data conveyed from the subsystem (37) to the subsystem (40) are processed to compute the historical quality characteristics of the loan portfolio and the macro-factor. The computed data of the loan portfolio quality characteristics come to the subsystem (38). The computed value of the macro-factor comes to the subsystem (39). The actual and estimated loan portfolio characteristics are compared at this stage. In case of substantial discrepancy between the actual and estimated characteristics the matching algorithm, the functional and the sequence of computation are changed (52). If the discrepancy between the actual and estimated characteristics of the loan portfolio is satisfactory, the summary data of quality characteristics are conveyed to the subsystems (38) and (39).

The subsystem (38) receives price policies and loan quality data from other systems and loan quality data from the loan portfolio characteristics computation subsystem (40). At this stage, business scenarios are generated and for each future loan vintage in each scenario a volume of extensions, quality and a schedule structure are set. The scenarios are conveyed to the subsystem (40) and to the report generation module (42).

The subsystem (39) receives the macroeconomic indicators and their forecasts and the macro-factor from the loan portfolio characteristics computation subsystem (40). At this stage, the macroeconomic scenarios and the macro-factor are generated. The scenarios are conveyed to the subsystem (40) and to the report generation module (42).

When the scenario characteristics of the portfolio are being computed, a planning horizon is set, computation procedures are selected from a general list (computations by losses, write-offs, duration computation, interest payment and principal payment computation and a plurality of other procedures) and the computation process is started. The computation results are conveyed to the subsystem (41) and to the report generation module (42).

When the market risk is being calculated, the interest rate data are loaded. The computation data on principal payments come from the subsystem (40). Data on principal payments on debt arising from new extensions, from current portfolio, on costs of funding (for various scenarios of interest rate performance), on interest payments, computation of expected and contingent losses from a market risk. The computed data are conveyed to the report generation module (42).

When the data are conveyed to the report generation module (42), the data are stored in the segment (36) of the hard drive (12) of the server 1. The data stored in the (36) of the hard drive are loaded into the cells (35) of RAM (11) of the server (1). The report generation module is capable of generating a plurality of reports to manage loan, market and strategic risks (financial income and expenditure plans, loan losses, reserves, market losses, capital adequacy, foreseen and unforeseen losses, etc.). The system operator has a wide range of choices of a method to set up and assemble data used for report generation. The system operation results may be represented by all suitable display facilities known in the art. Such facilities may include tables, graphs, visual light and audible sound signals, program, service, help or other prompts, etc.

The reports obtained after generation form a basis for selection of a management option which is most suited for imposed limitations and has the smallest values of risks, i.e., the best option of loan portfolio management is selected.

Then, the management option data thus selected are stored and a long-term work plan of such departments of the financial and credit organization as risk department, financial department, treasury, marketing department, price formation department and sales department is drawn up (corrected). Upon approval by an authorized person of the financial and credit organization such updated work plan comes into force and becomes available to the users working in the aforesaid departments.

The system allows the loan portfolios of third-party organizations to be analyzed and specific reports for such organizations to be generated in order to select professional recommendations optimizing loan portfolios management.

Further, the system may be used for research purposes by generating special-purpose reports to study the loan portfolio performance laws, to study the impact of the crisis on the loan portfolio, to study the crisis strength and crisis geography.

1. (canceled)

2. A loan portfolio management system including:
a server (1) and
at least one operator's workstation (2),
the at least one operator's workstation (2) being linked to the server (1),
the at least one operator's workstation (2) comprising:
a data input device (5);
a data receiving device (6) for receiving data on financial instruments, data on basic characteristics of the financial instruments, data on transactions with the financial instruments, data on risk factor historical values;
an interface (7) for intermediate data storage and processing; and
a data output device (9);
the server (1) comprising
a primary transfer matrix generator PTMG (37) to support transfer and loading of a main base of loan portfolio performance;
a business scenario generator BSG (38) for loading and generating business scenarios including loan portfolio qualitative characteristics historical, producing scenario quality characteristics and volumes of loan portfolio vintages and loading price policies;
a macro-factor value loader MFVL (39) for loading historical values of a macro-factor and producing scenario values of such macro-factor;
a multifactor estimator MFE (40) for computing vintage quality characteristics to calculate the macro-factor, for setting scenario characteristics of the loan portfolio, and for generating an error minimization functional;
a funding cost estimator FCE (41) for computing costs of funding, interest payments, losses as a result of market risk occurrence; and
a report generator RG (42) for generating reports on the basis of data calculated by the PTMG, BSG, MFVL, MFE, and FCE;
the PTMG, BSG, MFVL, MFE, FCE, and RG being controlled from the operator's workstation (2).
